(19) United States
(12) Patent Application Publication
(10) Pub. No.: US 2018/0143393 A1
(43) Pub. Date: May 24, 2018

(54) PORTABLE CABLE FEEDING DEVICE

(71) Applicant: DWIGHT ROSI, DELTONA, FL (US)

(72) Inventor: DWIGHT ROSI, DELTONA, FL (US)

(21) Appl. No.: 15/357,765

(22) Filed: Nov. 21, 2016

(51) Int. Cl. G02B 6/44; G02B 6/38

(52) U.S. Cl. CPC G02B 6/4466; G02B 6/3898

(57) ABSTRACT

A portable cable feeding device for feeding cables on receiving power from a motor. The portable cable feeding device includes a hollow tube, an indent configured on the hollow tube, a bearing unit to pass through the indent, a motor receiver unit attached to the bearing unit, and a handle to allow a user to hold the hollow tube while feeding the cable. The hollow tube is having a distal end and a front end. The distal end is open to receive the cable. The front end is open to dispense the cable. The cable runs along the length of the hollow tube. The bearing unit passes through the indent across the breadth of the hollow tube. The bearing unit rotates on receiving rotational power from the motor. The rotational bearing unit then moves the cable out from the front end.

### BACKGROUND OF THE DEVICE

### 1. Field of the Invention

The present invention generally relates to a cable-feeding device, and more particularly relates to a cable feeding device for feeding cables on receiving power from the motor.

### 2. Description of Related Art

As increasing use is made of computer networks and televisions, including the Internet, to provide information, demands have increased for increasingly fast delivery of that information. Fiber optic cable and television cables provide more information per second (called bandwidth), require less energy, and produce less heat than metal wire of the same thickness. Consequently there is an ever-increasing demand for fiber optic cable connections to homes and businesses.

Unlike metal wires and cables that already go to essentially all home and businesses in the form of telephone wires and power cables, fiber optic cables are available to only a small fraction of homes and businesses. Consequently there is an extensive effort underway to deliver fiber optic cable to more homes and businesses.

Cable trays are commonly used in industrial-type buildings for routing cable. The cable lays on top of the cable tray and is visible. The cable can be easily changed and additional cables can be easily added. When pulling cables into a cable tray, a guide system is required to control the cable location since a full enclosure (conduit) is not provided. Many current cable pulling accessories/feeders are fastened using loose pieces, such as screws and nuts that can easily be lost, dropped, or require extra hardware or hands to install quickly.

Other attachment methods include screw-driven clamps that require handles and repetitive twisting motion to grab onto one or both sides of the cable tray. Cam locks also exist, but require users to adjust settings if desiring use on a wider range of tray sizes. Therefore, there is a need for a portable cable feeding device to feed cable on receiving power from a motor to assist electricians in running cable through the building.

### SUMMARY OF THE INVENTION

In accordance with teachings of the present invention, a portable cable feeding device for feeding cables on receiving power from a motor is provided.

An object of the present invention is to provide a portable cable feeding device for feeding cables on receiving power from a motor. The portable cable feeding device includes a hollow tube, an indent configured on the hollow tube, a bearing unit to pass through the indent, a motor receiver unit attached to the bearing unit, and a handle to allow a user to hold the hollow tube while feeding the cable.

The hollow tube is having a distal end and a front end. The distal end is open to receive the cable. The front end is open to dispense the cable. The cable runs along the length of the hollow tube. The bearing unit passes through the indent across the breadth of the hollow tube. The bearing unit rotates on receiving rotational power from the motor. The rotational bearing unit then moves the cable out from the front end.

These and other features and advantages will become apparent from the following detailed description of illustrative embodiments thereof, which is to be read in connection with the accompanying drawings.

### BRIEF DESCRIPTION OF DRAWINGS

FIGS. 1 and 2 illustrate views of a portable cable-feeding device in accordance with a preferred embodiment of the present invention.

### DETAILED DESCRIPTION OF DRAWINGS

While this technology is illustrated and described in a preferred embodiment a portable cable feeding device for feeding cables on receiving power from a motor may be produced in various shapes, sizes, colors, and configuration. There is depicted in the drawings, and will herein be described in detail, as a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the technology described herein.

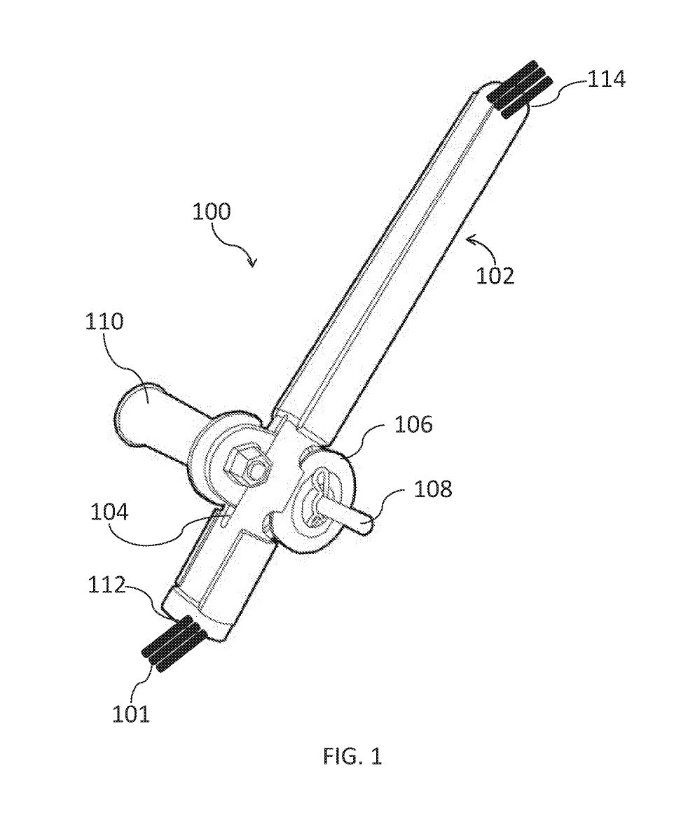

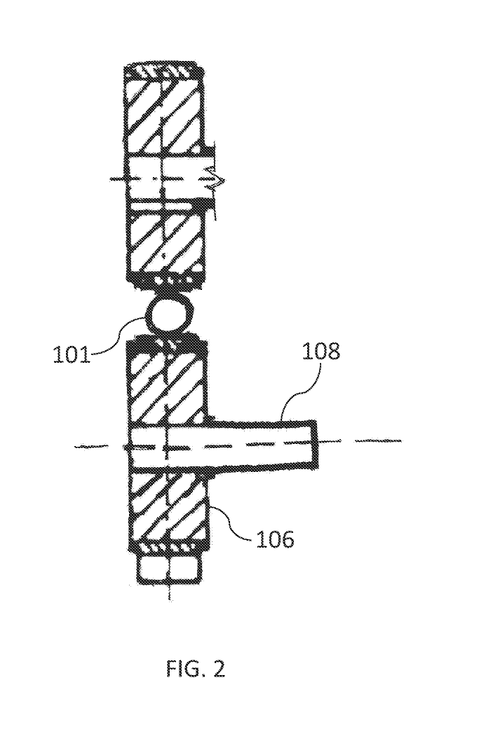

FIG. 1 illustrates a perspective view of a portable cable feeding device 100 in accordance with a preferred embodiment of the present invention. The portable cable feeding device 100 feeds cable 101 on receiving power from a motor. The portable feeding cable device 100 includes a hollow tube 102, an indent 104, a bearing unit 106, a motor receiver unit 108, and a handle 110.

The hollow tube 102 is having a distal end 112 and a front end 114. The distal end 112 is open to receive the cable 101. The front end 114 is open to dispense the cable 101. The cable 101 runs along the length of the hollow tube 102. There is a slot or indent 104 that is configured in the hollow tube 102 as shown. The bearing unit 106 passes through a bottom side of the indent 104 across the breadth of the hollow tube 102.

The motor receiver unit 108 is attached to the bearing unit 106 to receive the motor (not shown). The bearing unit 106 rotates on receiving rotational power from the motor. The rotational bearing unit 106 is pressed against the cable 101 and thus moves the cable 101 in the direction of the motor rotation and out from the front end 114. The handle 110 allows a user to hold the hollow tube 102 while feeding the cable 101 out of the tube 102.

In an exemplary embodiment, the portable cable feeding device 100 may be used by a cable company to run cable through the building in a more efficient and quick manner. It would be readily apparent to those skilled in the art that the portable cable feeding device 100 may be used by various companies for feeding cable for various purposes, without deviating from the scope of the present invention.

Many changes, modifications, variations and other uses and applications of the subject invention will, however, become apparent to those skilled in the art after considering this specification and the accompanying drawings which disclose the preferred embodiments thereof. All such changes, modifications, variations and other uses and applications which do not depart from the spirit and scope of the invention are deemed to be covered by the invention, which is to be limited only by the claims which follow.

1. A portable cable feeding device for dispensing cable by using a motor, comprising:
a) a tube having a distal end and a front end, wherein the distal end is open to receive the cable, and the front end is open to dispense the cable, wherein the cable runs along the length of the hollow tube;
b) an slot configured in the tube and positioned between the distal and front end, and extending from one side to an opposite side of the tube;
c) a bearing unit to pass through the slot across and contact the cable therein the tube;
d) a motor receiver unit attached to the bearing unit to receive the motor, designed to rotate the bearing unit on receiving rotational power from the motor and thereby moving the cable out from the front end; and
e) a handle to allow a user to hold the hollow tube while feeding the cable.
